(19) United States
(12) Patent Application Publication
(10) Pub. No.: US 2014/0141269 A1
(43) Pub. Date: May 22, 2014

(54) MIXTURES FOR COATING METAL SURFACES COMPRISING ORGANIC CORROSION INHIBITORS

(71) Applicant: BASF SE, Ludwigshafen (DE)

(72) Inventors: Christian SCHADE, Ludwigshafen (DE); Christian Maeder, Edingen-Neckarhausen (DE); Helmut Witteler, Wachenheim (DE)

(73) Assignee: BASF SE, Ludwigshafen (DE)

(21) Appl. No.: 14/080,966

(22) Filed: Nov. 15, 2013

Related U.S. Application Data
(60) Provisional application No. 61/727,763, filed on Nov. 19, 2012.

(51) Int. Cl. C09D 5/08; B32B 15/08

(52) U.S. Cl. CPC C09D 5/086; B32B 15/08
USPC 428/463; 427/427.5; 427/435; 427/355; 204/489

(57) ABSTRACT

A method for coating a metallic surface by contacting it with an aqueous copolymer dispersion, wherein the aqueous copolymer dispersion comprises an effective amount of organic phosphorus-containing corrosion inhibitors, the copolymers present in the dispersion being constructed from 20 to 95 weight % of monoethylenically unsaturated hydrocarbons and/or hydrocarbons having two conjugated double bonds, from 5 to 80 weight % of monoethylenically unsaturated monomers which contain acid groups, and/or anhydrides or salts thereof. A metallic surface coated with a copolymer, obtainable by methods of this kind, which can also further comprise one or more layers of paint applied one atop another.

The present invention relates to methods for coating metallic surfaces by bringing the metallic surface into contact with aqueous copolymer dispersions. The invention further relates to copolymer-coated metallic surfaces and also to the use of aqueous copolymer dispersions to coat metallic surfaces.

Further embodiments of the present invention can be found in the claims, description, and examples. It will be appreciated that the features of the subject matter of the invention that have been identified above, and those still to be elucidated below, can be used not only in the respective combination specifically indicated but also in other combinations as well without departing from the scope of the invention. Preferred and especially preferred embodiments of the present invention, respectively, are more particular those embodiments in which all of the features of the subject matter of the invention have the preferred and especially preferred definitions, respectively.

The coating of surfaces by aqueous copolymer dispersions is known.

WO 2004/108601 A1 describes the use of aqueous dispersions comprising at least one at least partly neutralized ethylene copolymer wax, selected from those ethylene copolymer waxes which comprise as comonomers in copolymerized form (A) 26.1 to 39 weight % of at least one ethylenically unsaturated carboxylic acid and (B) 61 to 73.9 weight % of ethylene, and those ethylene copolymer waxes which comprise in copolymerized form (A′) 20.5 to 38.9 weight % of least one ethylenically unsaturated carboxylic acid, (B′) 60 to 79.4 weight % of ethylene, and (C′) 0.1 to 15 weight % of at least one ethylenically unsaturated carboxylic ester, as auxiliaries for wastewater treatment. The partly neutralized ethylene copolymer waxes are at least partially neutralized with a basic substance, preferably an amine. The basic substance may also be a carbonate and/or hydrogencarbonate of an alkali metal. The equipment of dispersions of this kind with additional additives is not described.

WO 2008/092853 A1 describes a method for coating surfaces by treating them with a substantially paraffin-free formulation which comprises a copolymer at least partly neutralized with an alkali metal and made from ethylene and 25.5-35 weight % of an ethylenically unsaturated carboxylic acid. The formulation further comprises at least one nonionic or anionic surfactant, at least one defoamer, and optionally further components. The basic component may also be a carbonate and/or hydrogencarbonate of an alkali metal. The equipment of dispersions of this kind with additional additives is not described.

WO 2007/137963 A1 describes a method for coating plastics or metallic surfaces with an aqueous dispersion of ethylene copolymers having a molar mass in the range of 2000-20 000 g/mol, comprising in copolymerized form 15.5-19.9 weight % of an ethylenically unsaturated carboxylic acid, and comprising at least one base, the coated surfaces being provided with at least one further coat. Examples of the selected base are alkali metal salts and more preferably amines. Mention may be made, as further suitable additives, of anticorrosion pigments, especially Zn salts or organic corrosion control inhibitors. A more precise description of these additives is not given.

WO 2006/066824 A1 describes a method for coating metallic surfaces with a copolymer of olefins and/or dienes, acidic monomers, and also, optionally, further monomers, the metal surfaces being contaminated with oil and/or grease and the contamination not being removed prior to coating. The polymers used are neutralized by a base. The formulations used may optionally comprise further components, for example corrosion inhibitors. There is no further description of these components.

WO 98/10023 describes the use of aqueous polymer dispersions comprising a polymer made from an olefin and from an acidic comonomer, at least one colorant and/or a corrosion inhibitor to protect metallic surfaces against corrosion. The corrosion inhibitors used are preferably pigments which are insoluble in the aqueous phase and which limit the transparency and surface properties of the films. This document does not make references to the use of phosphorus-containing organic corrosion control inhibitors.

The above-described dispersions are still deserving of improvement in relation to corrosion control of metallic surfaces, especially with regard to the passivation of surfaces comprising steel and/or zinc or zinc-containing alloys.

It was an object of the invention to provide an improved method for treating metallic surfaces that can be employed with particular advantage in the passivation of surfaces comprising steel and/or zinc or zinc-containing alloys.

As is evident from the disclosure content of the present invention, these and other objects are achieved by means of the various embodiments of the preparations of the invention.

One subject of the invention is therefore a method for coating metallic surfaces by bringing the metallic surface into contact with an aqueous copolymer dispersion, wherein the aqueous copolymer dispersion comprises an effective amount of organic phosphorus-containing corrosion inhibitors (K1), the copolymers present in the dispersion being constructed from the following components:
(A) from 20 to 95 weight % of monoethylenically unsaturated hydrocarbons and/or hydrocarbons having two conjugated double bonds,
(B) from 5 to 80 weight % of monoethylenically unsaturated monomers which contain acid groups, and/or anhydrides or salts thereof.

Here, the amount of components (A) and (B) is based on the total amount of components (A) and (B). The total amount of components (A) and (B) here is 100 weight %. The components (A) are present preferably in the range from 20 to 95 weight % and (B) in the range from 5 to 50 weight %.

Surprisingly it has been found that metal surfaces treated with the method of the invention are significantly more resistant to corrosion than those in accordance with the prior art.

An aqueous copolymer dispersion for the purposes of the present invention is a mixture comprising water and copolymers. The water here is present in an aqueous solvent mixture, with the aqueous solvent mixture being composed substantially, more preferably completely, of water. The copolymer may be present in dispersion, in emulsion or else as a molecular solution in the aqueous solvent mixture.

The aqueous solvent mixture contains preferably from 75 weight % to 100 weight % of water. Besides water, the aqueous solvent mixture may optionally comprise organic solvents as well. The organic solvents preferably comprise compounds selected from the group consisting of alcohols, ethers, esters, ketones, and amides. Organic solvents of this kind are frequently used as an ingredient of paints, and are known to the skilled person from the prior art. Examples of such solvents are alcohols such as methanol, ethanol, propanol, butanol, phenoxypropanol, or ethylene glycol, ketones such as acetone, methyl ethyl ketone, cyclohexanone, oligomeric and optionally partially etherified alkylene glycol ethers such as, for example, diethylene glycol, triethylene glycol, tetraethylene glycol, butyl glycol, butyl diglycol, 2,2,4-trimethyl-1,3-pentanediol monoisobutyrate, dimerized butyl glycol, dipropylene glycol n-butyl ether, dipropylene glycol dimethyl ether, esters such as the dimethyl esters of adipic acid, succinic acid, and glutaric acid, and mixtures thereof, 2-ethylhexyl lactate, butyl phthalate, dibutyl phthalate, amides such as dimethylacetoacetamide, N-methylpyrrolidone, or N,N-dimethyllactamide. In small amounts it is also possible to use water-immiscible solvents, examples being hydrocarbons. The small amounts in this case are selected such that no visible additional phase is formed; the small amount is typically less than 5 weight % based on the overall mixture.

The copolymers in the aqueous solvent mixture are present preferably in largely molecularly disperse form or in the form of a very fine dispersion having an average particle size of below 100 nm, determined by dynamic light scattering in accordance with DIN ISO 13321. This means that they do not lead to significant changes in the transparency of the aqueous solvent, let alone to the formation of a sediment.

The copolymers preferably have molecular weights M_{w} (weight average) of above 20 000 g/mol, very preferably of above 50 000 g/mol. More particularly the molecular weights of the copolymers are in the range from 20 000 g/mol to 200 000 g/mol, very preferably from 50 000 g/mol to 200 000 g/mol.

In one preferred embodiment of the method of the invention, the copolymers present in the dispersion comprise as a further component:
(C) from 0 to 30 weight % of ethylenically unsaturated monomers different from (A) and (B).

Here, the amount of components (A), (B), and (C) is based on the total amount of components (A), (B), and (C). The total amount of the components (A), (B), and (C) here is 100 weight %.

In another preferred embodiment of the method of the invention, the total amount of organic phosphorus-containing corrosion inhibitors (K1) is in the range from 0.1 to 20 weight %, based on the amount of the copolymers, preferably in the range from 0.2 to 10%, more preferably in the range from 0.4 to 5 weight %.

For the purposes of the method of the invention, organic phosphorus-containing corrosion inhibitors (K1) used are preferably phosphinates, phosphonates, or phosphates, which contain at least one C atom, it being possible to use the organic phosphorus-containing corrosion inhibitors (K1) as free acids or in the form of their salts.

Very preferably the organic phosphorus-containing corrosion inhibitors (K1) are
etidronic acid, 2-carboxyethylphosphonic acid, bis(2,4,4-trimethylpentyl)phosphinic acid, (2,4,4-trimethylpentyl)phosphonic acid, 2-phosphono-1,2,4-butanetricarboxylic acid, phytic acid,
mono- and dialkyl phosphates or the corresponding phosphonates, examples being 2-ethylhexyl, ethyl, butyl, amyl, octyl, isooctyl, decyl, dodecyl, diethyl or di-(2-ethylhexyl) phosphate,
aminomethylenephosphonic acids such as, for example, ethylenediaminetetra-(methylenephosphonic acid), aminotrimethylenephosphonic acid, ethanolamine-bis(methylenephosphonic acid), diethylenetriaminepenta(methylenephosphonic acid), bishexamethylenetriaminepenta(methylenephosphonic acid), hexamethylene-diaminetetra(methylenephosphonic acid),
phosphonic acid [(tetrahydro-2-hydroxy-4H-1,4,2-oxazaphosphorin-4-yl)methyl] P-oxides, or
myristamidopropylphosphoric acid.

Very preferably the organic phosphorus-containing corrosion inhibitors (K1), furthermore, are polymers of alkylene oxides which have been reacted to form monophosphate or diphosphate esters, or are alcohols which have been reacted to form phosphoric esters. These alcohols are preferably compounds having 2-32 C atoms, more particularly those having 2-22 C atoms.

Very preferably the phosphorus-containing corrosion inhibitors (K1), furthermore, do not comprise any fluorine.

In a further preferred embodiment of the method of the invention, the aqueous copolymer dispersion comprises an effective amount of further corrosion inhibitors (K2), which are different from the corrosion inhibitors (K1). Preferred further corrosion inhibitors (K2) are alkylenesuccinamides, alkenylsuccinic esters, alkenylsuccinic monoesters, triazinetriyl-triiminocarboxylic acids, benzylpyridine-3-carboxylates, benzo- and tolyltriazole, and water-soluble derivatives, thioureas, and mercaptans, optionally having undergone reaction with alkylene oxides.

In one preferred embodiment of the method of the invention, component (A) is at least one alkene selected from the group consisting of ethene, propene, 1-butene, 2-butene, 1-pentene, 1-hexene, 1-heptene, and 1-octene.

In another preferred embodiment of the method of the invention, the acidic group in (B) is at least one group selected from the group consisting of carboxyl groups, sulfonic acid groups, and phosphonic acid groups.

More preferably component (A) is ethene and component (B) is (meth)acrylic acid.

In one preferred embodiment of the method of the invention, 0.5 to 80 mol % of the acid groups present in the copolymer are present in the form of neutralized groups. This neutralization is accomplished preferably by dispersing the polymer in the solvent with addition of the base at an elevated temperature.

Bases used are typically one or more substances having a basic action, examples being hydroxides and/or carbonates and/or hydrogencarbonates of alkali metals, or, preferably, amines such as ammonia, for example, and organic amines such as alkylamines, N-alkylethanolamines, alkanolamines, and polyamines, for example.

Examples of alkylamines include the following: triethylamine, diethylamine, ethylamine, trimethylamine, dimethylamine, methylamine. Preferred amines are monoalkanolamines, N,N-dialkylalkanolamines, N-alkylalkanolamines, dialkanolamines, N-alkylalkanolamines and trialkanolamines having in each case 2 to 18 C atoms in the hydroxyalkyl radical and optionally in each case 1 to 6 C atoms in the alkyl radical, preferably 2 to 6 C atoms in the alkanol radical and optionally 1 or 2 C atoms in the alkyl radical. Especially preferred are ethanolamine, diethanolamine, triethanolamine, methyldiethanolamine, n-butyldiethanolamine, N,N-dimethylethanolamine, and 2-amino-2-methylpropan-1-ol. Especially preferred are ammonia and N,N-dimethylethanolamine. Examples of polyamines that may be mentioned include the following: ethylenediamine, tetramethylethylenediamine (TMEDA), diethylenetriamine, and triethylenetetramine.

The copolymers are prepared by methods known to the skilled person. For example, the copolymers are prepared in accordance with the methods described in WO 2004/108601 A1.

The mixtures of copolymer and aqueous solvent mixture are prepared by methods known to the skilled person. For example, the copolymer is dispersed in the solvent mixture produced by mixing beforehand.

In the context of the method of the invention it is preferred to use the copolymer in the form of a formulation with water or with an aqueous solvent mixture comprising least 75 weight % water. It is particularly preferred in this case for the copolymer to be formulated only in water as solvent, and for the concentration of the copolymer to be 0.5 to 50 weight %, relative to the sum of all the components of the formulation.

The aqueous copolymer dispersions in the method of the invention are applied to the metallic surface preferably by means of injecting, spraying, dipping, spread-coating, or electrophoretic painting. These method steps may also be carried out two or more times in succession.

Hereinbelow, the aqueous copolymer dispersions applied are preferably dried at temperatures in the range from 20 to 180° C.

The method of the invention can be used to coat a multiplicity of metallic surfaces. The metallic surface preferably comprises a metal selected from the group consisting of Mg, Al, steel, Zn, and steel coated with Zn, Al, Ni, Sn, Cr, or alloys thereof; more preferably the metallic surface comprises the metal Zn.

In another embodiment of the method of the invention, the aqueous copolymer dispersion is contacted with an intermediate coat, the intermediate coat being in contact with the metallic surface. The intermediate coat is preferably a conversion coat which serves to passivate the metal surface. Examples of such coats are Cr conversion coats, phosphation coats, polymer-based aftertreatments, passivating coats comprising Ti compounds or Zr compounds, metal oxide coats, layer-by-layer coats, silane-crosslinked coats or oils, especially anticorrosion oils. The intermediate coat is preferably a Cr conversion coat. These conversion coats are generated, as the skilled person is aware, from acidic (pH 0.5 to 5) Cr(III)- or Cr(VI)-containing solutions which include an oxidizing agent (such as NO₃_{^{−}}). The Zn surface here is minimally dissolved, and the consequent pH increase at the surface is accompanied by the formation of a Cr- and Zn-containing oxidic/hydroxidic network which, according to application parameters (temperature, solution pH, application time) has a coat thickness of 20 nm to 2 μm. The chromating, chromiting or passivating coats, as they are called, are known from the prior art (US19810265487, DE19638176A). It is also possible to remove some or all of the intermediate coat prior to treatment with the aqueous copolymer dispersion, such removal taking place for example in an alkaline cleaning bath. Oiled substrates which have not been degreased or have been only partly degreased may be treated directly with the copolymer dispersion by the method of the invention.

In a further embodiment of the method of the invention, copolymer dispersions comprise, as a further component, wetting agents, film formers, crosslinking components, or other corrosion inhibitors different from the copolymers.

The copolymer dispersions may additionally, as described above, be admixed with film-forming assistants. The latter may be solvents or solvent mixtures, especially those having an evaporation number according to DIN 53170 in the 50-20 000 range, examples being butyl glycol or butyl diglycol. It is also possible, however, to add non-evaporating compounds, especially alcohols which have been reacted with alkylene oxides, more particularly ethylene oxide and/or propylene oxide. These alcohols may be monohydric or polyhydric. These compounds may result in better spreading of the solution on the metal surface. Use may also be made of alkoxylates of oligomeric or polymeric alcohols, such as of silicone derivatives, for example.

The addition of further components is possible as described above—examples are crosslinking components such as various silicon compounds, nanoparticles, components with epoxy and/or isocyanate groups, and also corrosion inhibitors differing from the copolymers. Examples of suitable silicon compounds are silyl ethers and silanols of the formula Y,X—Si—(OR)₃₋ₓ, where X and Y are any desired organic radicals, R is H or alkyl, and x is 0 or 1. These compounds may also be nanoparticulate dispersions or oligomeric compounds that have already undergone preliminary condensation.

Wetting agents as well may—as described above—be added to the copolymer dispersions. Examples of suitable wetting agents are nonionic, anionic, or cationic surfactants, more particularly ethoxylation and/or propoxylation products of fatty alcohols, or propylene oxide-ethylene oxide block copolymers, ethoxylated or propoxylated fatty alcohols or oxo-process alcohols, and also ethoxylates of oleic acid or alkylphenols, alkylphenol ether sulfates, alkylpolyglycosides, alkylphosphonates, alkylphenylphosphonates, alkyl phosphates, or alkylphenyl phosphates. Further examples are, in particular, polyethoxylated C₁₀-C₃₀ fatty alcohols or polyethoxylated C₁₁-C₃₁ oxo-process alcohols.

Preference is given to using low-foam wetting agents, examples being endgroup-capped ethoxylation and/or propoxylation products of fatty alcohols, where the alcoholic end group has been reacted to give an ether, a methyl ether or ethyl ether, for example.

Particularly preferred wetting agents are alkoxylated fatty alcohols of the formula (I)

R¹—(OCH₂CHR²)ₓ(OCH₂CHR³)_{y}-OR⁴ (I)
where
R¹ is C₆-C₂₄ alkyl, linear or branched,
R² and R³ are H or C₁-C₁₆ alkyl, linear or branched,
R⁴ is H or C₁-C₈ alkyl, linear or branched,
x is an integer from the range from 1 to 200, and
y is an integer from the range from 0 to 80.

The alkylene oxide units in formula (I) may be arranged in one or more blocks or randomly.

The present invention further provides a copolymer-coated metallic surface obtainable according to any embodiment of the method of the invention.

Generally speaking, the thickness of the copolymer-containing layer on the metallic surface is from 0.1 to 30 μm, preferably from 0.2 to 30 μm, more preferably from 0.5 to 10 μm, very preferably from 1 to 6 μm.

In one embodiment of the coated metallic surface of the invention there are also one or more paint layers, applied one above another, present on the copolymer-containing layer.

In general the coated metallic surfaces may take on any desired form. The metallic surfaces are preferably surfaces of shaped or sheetlike bodies, more preferably the surface of coils, wires, tubes, panels, workpieces, shaped parts, joined parts and/or connected parts.

The copolymer dispersions may be applied to sheetlike or shaped metal surfaces, as for example to coils, wires, and tubes, or to other shaped or sheetlike bodies.

When shaped bodies are used, the copolymer dispersions are applied preferably by dipping or spraying methods. After drying in this case, the applied films have a preferred average coat thickness in the range from 0.2 to 30 μm, more particularly from 0.5 to 10 μm, very preferably from 1 to 6 μm.

Drying may take place by various methods. In many cases, conventional drying at slightly elevated temperature is sufficient. The workpieces (shaped or sheetlike bodies) are preferably stored in an oven at 80° C. for 5 to 20 minutes. As and when necessary, however, higher temperatures in the range from 80 to 180° C. and longer or shorter times may be arranged.

A further subject of the present invention is the use of aqueous copolymer dispersions comprising an effective amount of organic phosphorus-containing corrosion inhibitors (K1), the copolymers present in the dispersion being constructed from the following components:
(A) from 20 to 95 weight % of monoethylenically unsaturated hydrocarbons and/or hydrocarbons having two conjugated double bonds,
(B) from 5 to 80 weight % of monoethylenically unsaturated monomers which contain acid groups, and/or anhydrides or salts thereof
   to coat metallic surfaces.

Here, the amount of components (A) and (B) is based on the total amount of components (A) and (B). The total amount of components (A) and (B) here is 100 weight %. The components (A) are present preferably in the range from 20 to 95 weight % and (B) in the range from 5 to 50 weight %.

In one preferred embodiment of the use in accordance with the invention, the copolymers present in the dispersion comprise as a further component:
(C) from 0 to 30 weight % of ethylenically unsaturated monomers different from (A) and (B).

Here, the amount of components (A), (B), and (C) is based on the total amount of components (A), (B), and (C). The total amount of the components (A), (B), and (C) here is 100 weight %.

The total amount of organic phosphorus-containing corrosion inhibitors (K1) here is in the range from 0.1 to 20 weight %, based on the amount of copolymers, preferably in the range from 0.2 to 10%, more preferably in the range from 0.4 to 5 weight %.

In the context of use in accordance with the invention, the aqueous copolymer dispersions are preferably contacted with an intermediate coat, the intermediate coat being in contact with the metallic surface.

With particular preference in the context of the use in accordance with the invention, the coatings are used as what are called sealers, with a Cr conversion coat acting as an intermediate coat. The sealer in this case leads to a distinct improvement in the corrosion control properties of the Cr conversion coat.

The present invention provides improved methods for the treatment of metallic surfaces, which can be employed with particular advantage in the passivation of surfaces comprising steel and/or zinc or zinc-containing alloys.

The invention is illustrated by the examples, without the examples restricting the subject matter of the invention.

### EXAMPLES

The polymers A and B are prepared by free-radical high-pressure polymerization as described, for example, in EP 1636137 B1.

### Polymer A:

An aqueous solution of 21 weight % (based on the amount of water) of a copolymer of ethylene and acrylic acid in a 70:30 weight ratio, having a molecular weight of approximately 30 000 D, and 3.5 weight % of the base dimethylethanolamine (based on the amount of water).

### Polymer B:

An aqueous solution of 21 weight % (based on the amount of water) of a copolymer of ethylene and methacrylic acid in a 73:37 weight ratio, having a molecular weight of approximately 90 000 D, and 3.5 weight % of the base dimethylethanolamine (based on the amount of water).
Additive 1: phosphorylated polypropylene oxide with a molar mass of 2000 g/mol
Additive 2: tetrapropylenesuccinamide
Additive 3: 6,6′,6″-(1,3,5-triazine-2,4,6-triyltriimino)hexanoic acid, triethanolamine salt
Additive 4: etidronic acid

The corresponding additives were added to the polymers A or B, and the solutions were then stirred for at least 3 hours. The amount of the selected additive in weight % is based on the amount of polymer used.

For this purpose, additives 1 and 4 were predissolved in a small amount of water, and an equimolar amount of dimethylethanolamine was added. The amount of the water was selected for this purpose such that mixing gave a corrosion inhibitor-containing polymer solution having a solids content of 20 weight %.

Additives 2 and 3 were added directly to the solution of the polymer. In each case, finally, the solids content was adjusted to a level of 20 weight %.

Oiled galvanized metal panels (dimensions about 220 mm*10 mm*0.5 mm, Zn add-on 100 g/m²) were immersed in ethyl acetate for around 1 minute and then rubbed down with a paper towel.

They were then placed for 30 seconds at 60° C. in a bath of an alkaline cleaning solution (Surtec 133, 4% strength). After that they were immersed several times into a bath containing water at 60° C., and then into a bath containing fully demineralized water, then allowed to drip dry, and blown off with compressed air.

The dry metal panels were coated by doctor-blade application of the polymer solutions. The doctor blades in this case were selected so as to produce a wet film thickness of 12 μm. The metal panels were subsequently dried in a forced-air drying oven (about 12 seconds, PMT (peak metal temperature) 50° C.), and then stored in a drying oven at 120° C. for 1 hour.

After 48 hours of storage in the laboratory, the metal panels were subjected to a neutral salt spray mist test in accordance with DIN EN ISO 9227. The time t9 in hours before the occurrence of initial traces of corrosion (degree of corrosion control <10, according to EN ISO 10289:2001), was ascertained.

| | | Additive | Amount of additive | Additive | Amount of additive | |
|---|---|---|---|---|---|---|
| Example | Polymer | A | A (weight %) | B | B (weight %) | t9 |
| Comparative | A | | | | | 24 |
| example 1 | | | | | | |
| 1 | A | 1 | 1 | | | 48 |
| 2 | A | 1 | 1 | 3 | 3 | 96 |
| 3 | A | 1 | 1 | 4 | 3 | 96 |
| 4 | A | 4 | 3 | 1 | 1 | 72 |
| Comparative | B | | | | | 24 |
| example 2 | | | | | | |
| 5 | B | 1 | 1 | | | 48 |
| 6 | B | 1 | 1 | 4 | 3 | 72 |
| 7 | B | 1 | 1 | 3 | 3 | 72 |
| 8 | B | 1 | 0.5 | 4 | 2 | 72 |
| 9 | B | 4 | 2 | 3 | 2 | 72 |

The amount of additive A or B is based on the amount of copolymer.

The examples show the advantageous corrosion control produced by adding the P-containing corrosion control additives. This effect can be further increased by adding further corrosion control additives to the mixture.

1. A method for coating a metallic surface, the method comprising contacting the metallic surface with an aqueous copolymer dispersion, wherein the aqueous copolymer dispersion comprises a copolymer and an effective amount of a corrosion inhibitor comprising organic phosphorus, wherein the copolymer comprises, in polymerized form:
(A) from 20 to 95 weight % of a monoethylenically unsaturated hydrocarbon, a hydrocarbon having two conjugated double bonds, or both,
(B) from 5 to 80 weight % of a monoethylenically unsaturated monomer comprising an acid group, or anhydrides or salts thereof,
wherein the corrosion inhibitor is at least one member selected from the group consisting of etidronic acid, 2-carboxyethylphosphonic acid, bis(2,4,4-trimethylpentyl)phosphinic acid, (2,4,4-trimethylpentyl)phosphonic acid, 2-phosphono-1,2,4-butanetricarboxylic acid, phytic acid, a monoalkyl phosphate, a dialkyl phosphate, a monoalkyl phosphonate, a dialkyl phosphonate, an aminomethylenephosphonic acid, a phosphonic acid [(tetrahydro-2-hydroxy-4H-1,4,2-oxazaphosphorin-4-yl)methyl] P-oxide, myristamidopropylphosphoric acid, a polymer of an alkylene oxide that has been reacted to form a monophosphate or diphosphate ester, and an alcohol that has been reacted to form a phosphoric ester, and
wherein the corrosion inhibitor does not comprise any fluorine.

2. The method of claim 1, wherein the copolymer further comprises, in polymerized form:
(C) from 0 to 30 weight % of an ethylenically unsaturated monomer different from (A) and (B).

3. The method of claim 1, wherein a total amount of the inhibitor in the aqueous copolymer dispersion is in a range from 0.1 to 20 weight %, based on an amount of the copolymer.

4. The method of claim 1, wherein component (A) is at least one alkene selected from the group consisting of ethene, propene, 1-butene, 2-butene, 1-pentene, 1-hexene, 1-heptene, and 1-octene.

5. The method of claim 1, wherein the acid group in component (B) is at least one group selected from the group consisting of a carboxyl group, a sulfonic acid group, and a phosphonic acid group.

6. The method of claim 1, wherein 0.5 to 80 mol % of the acid groups present in the copolymer are neutralized.

7. The method of claim 1, wherein the contacting is performed by spraying, injecting, dipping, spread-coating or electrophoretic painting.

8. The method of claim 1, wherein the metal present in the metallic surface is one selected from the group consisting of Mg, Al, steel, Zn, and steel coated with Zn, Al, Ni, Sn, Cr or alloys thereof.

9. The method of claim 1, wherein the aqueous copolymer dispersion is contacted with an intermediate coat, the intermediate coat being in contact with the metallic surface.

10. The method of claim 9, wherein the intermediate coat is a Cr conversion coat.

11. The method of claim 1, wherein the copolymer dispersion further comprises a wetting agent, a film-former, a crosslinking component, or another corrosion inhibitor different from the copolymer.

12. A copolymer-coated metallic surface obtained by the method of claim 1.

13. The coated metallic surface of claim 12, comprising one or more paint coats applied one over another located on a coat comprising the copolymer.

14-15. (canceled)

16. The method of claim 1, wherein the copolymer further comprises, in polymerized form, an ethylenically unsaturated monomer different from (A) and (B).

17. The method of claim 1, wherein component (A) is a monoethylenically unsaturated hydrocarbon.

18. The method of claim 1, wherein component (A) is a hydrocarbon having two conjugated double bonds.

19. The method of claim 1, wherein component (A) is ethane.

20. The method of claim 1, wherein the acid group in component (B) is a carboxyl group.

21. The method of claim 1, wherein the acid group in component (B) is a sulfonic acid group.

22. The method of claim 1, wherein the acid group in component (B) is a phosphonic acid group.
